(19) United States
(12) Patent Application Publication
(10) Pub. No.: US 2026/0303389 A1
(43) Pub. Date: Oct. 1, 2026

(54) DIGITAL INTERCOM

(71) Applicant: Bosch Security Systems, LLC., Burnsville, MN (US)

(72) Inventors: Jiaying Wang, Woodbury, MN (US); Manoj Shirahatti, Plymouth, MN (US); James H. Puttick, Scarborough (CA)

(21) Appl. No.: 19/097,545

(22) Filed: Apr. 1, 2025

(51) Int. Cl. H04L 12/18; G06F 3/0482

(52) U.S. Cl. CPC H04L 12/1818; G06F 3/0482; H04L 12/1822

(57) ABSTRACT

A system for providing a digital intercom. The system includes an electronic processor. The electronic processor is configured to generate a digital intercom instance in a cloud environment, generate an instance of a web application associated with the digital intercom instance, and receive, via the instance of the web application, a request to activate one or more communication channels. The electronic processor is also configured to, in response to the request to activate the one or more communication channels, activate the one or more communication channels. The electronic processor is further configured to receive, via the instance of the web application, a request to allow one or more user devices access to the one or more communication channels and permit the one or more user devices access to the one or more communication channels via a mobile application.

### SUMMARY

Intercom systems aid in providing audio communications in a wide range of situations including television broadcasts and ceremonies in houses of worship. Intercom systems help professionals communicate clearly with ease and efficiency. However, many intercoms remain hardware based and therefore are limited by a fixed number of communication channels/ports, require capital expenditure investment, require maintenance, have a limited life (need to be replaced after a time), and allow for only limited mobility for users of the hardware-based intercom.

Implementations described herein provide a cloud based digital intercom solution for digital based hardware matrices and hardware based key panels. The digital intercom described herein offers the same functionalities as hardware-based matrices and key panels. Additionally, the digital intercom described herein may provide a solution to the above mentioned shortcomings associated with hardware-based intercoms. For example, the cloud based digital intercom described herein provides, among other things, greater scalability by providing a greater number of communication channels as the number of communication channels in the digital intercom is not limited by a number of physical ports available. The digital intercom described herein may also be capable of mixing a greater amount of audio data than hardware-based intercoms. In some instances, the digital intercom also provides greater remote production capability or greater mobility for users communicating via the digital intercom as users are able to connect to the digital intercom via a mobile device application. In some instances, the digital intercom described herein also provides operational efficiency. As will be described in further detail below, users may manage a number of communication channels available in a digital intercom and control a time period or activation period for which the communication channels are available. This ability to control when communication channels are available and a number of communication channels which are available ensures the cloud computing resources are conserved. In some instances, the digital intercom described herein also provides financial efficiency to users by allowing intercom users to move from a capital expenditures model to an operational expenditures model. For example, in hardware-based intercoms a user must purchase and install equipment needed to run the intercom even if the intercom is rarely used. In this capital expenditures model, users must invest a large amount of money for a system they may rarely use. Using the digital intercom described herein, users need only to pay for the number of communication channels they plan to use and for the time they plan to use the communication channels.

In some implementations, the digital intercom described herein provides scalability, connectivity, mobility, and reliability. The digital intercom may provide scalability because users may add and disable communication channels as needed. The digital intercom may provide connectivity by allowing users around the world to collaborate in real time. The digital intercom may provide mobility by allowing users to connect to the digital intercom using a mobile application. The digital intercom may provide reliability by providing uninterrupted and secure communications.

One example implementation provides a system for providing a digital intercom. The system includes an electronic processor. The electronic processor is configured to generate a digital intercom instance in a cloud environment, generate an instance of a web application associated with the digital intercom instance, and receive, via the instance of the web application, a request to activate one or more communication channels. The electronic processor is also configured to, in response to the request to activate the one or more communication channels, activate the one or more communication channels. The electronic processor is further configured to receive, via the instance of the web application, a request to allow one or more user devices access to the one or more communication channels and permit the one or more user devices access to the one or more communication channels via a mobile application.

Another example implementation provides a method for providing a digital intercom. The method includes generating a digital intercom instance in a cloud environment, generating an instance of a web application associated with the digital intercom instance, and receiving, via the instance of the web application, a request to activate one or more communication channels. The method also includes, in response to the request to activate the one or more communication channels, activating the one or more communication channels. The method further includes receiving, via the instance of the web application, a request to allow one or more user devices access to the one or more communication channels and permitting the one or more user devices access to the one or more communication channels via a mobile application.

### BRIEF DESCRIPTION OF THE DRAWINGS

FIG. 1 is a block diagram of an example system for providing a digital intercom, in accordance with some implementations.

FIG. 2 is an example block diagram of the components included in a server of the system illustrated in FIG. 1, in accordance with some implementations.

FIG. 3 is an example block diagram of the components included in a user device of the system illustrated in FIG. 1, in accordance with some implementations.

FIG. 4 is an example block diagram of the components included in a user device of the system illustrated in FIG. 1, in accordance with some implementations.

FIG. 5 is a flowchart of an example method for providing a digital intercom, in accordance with some implementations.

FIG. 6 is an example GUI for requesting to activate one or more communication channels, in accordance with some implementations.

FIG. 7 is example graphical user interface (GUI) of a web application, in accordance with some implementations.

FIG. 8 is an example of a popup displayed in a web application, in accordance with some implementations.

FIG. 9 is an example GUI prompting scanning a quick response (QR) code, in accordance with some implementations.

FIG. 10 is an example GUI generated when a QR code is scanned, in accordance with some implementations.

FIG. 11 is an example GUI including a plurality of tiles, in accordance with some implementations.

FIG. 12-FIG. 19 are example GUIs, in accordance with some implementations.

FIG. 20 is an example block diagram of software components included in a system for implementing a digital intercom, in accordance with some implementations.

FIG. 21 is an example block diagram of functionality performed when a digital intercom instance is executed, in accordance with some implementations.

FIG. 22 is an example diagram depicting communications between hardware matrixes and a server included in the system of FIG. 1, in accordance with some implementations.

FIG. 23 is an example GUI via which selections of communication channel assignments may be received, in accordance with some implementations.

### DETAILED DESCRIPTION

Before any implementations, examples, aspects, and features are explained in detail, it is to be understood that they are not limited in their application to the details of construction and the arrangement of components set forth in the following description or illustrated in the following drawings. Other implementations, examples, aspects, and features are possible, and they are capable of being practiced or of being carried out in various ways.

For ease of description, some or all of the example systems presented herein are illustrated with a single exemplar of each of its component parts. Some examples may not describe or illustrate all components of the systems. Other examples may include more or fewer of each of the illustrated components, may combine some components, or may include additional or alternative components.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some implementations, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

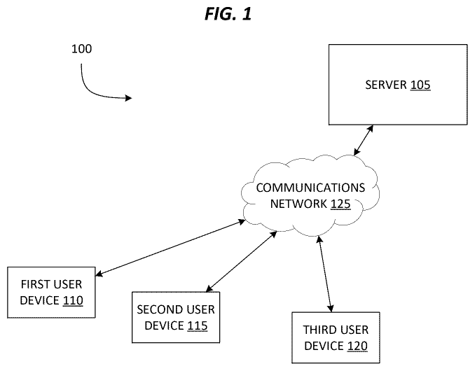

FIG. 1 is an example system 100 for providing a digital intercom. In some implementations, the system 100 includes a server 105, a first user device 110, a second user device 115, and a third user device 120. While the system 100 is illustrated as including a single server, in some implementations, the system 100 may include multiple servers and the functionality described as being performed by the server 105 may be in fact be performed by multiple servers. Additionally, the system 100 may include a different number of user devices than the three user devices illustrated in FIG. 1. The user devices may be, for example, a desktop computer, a lap top computer, a tablet, a smart phone, a smart wearable, a combination of the foregoing, or the like. In some implementations, the user devices 110, 115, and 120 are configured to communicate with the server 105 through a communications network 125. The communications network 125 is a communications network including wireless connections, wired connections, or combinations of both. The communications network 125 may be implemented using a wide area network, for example, the Internet, a Long-Term Evolution (LTE) network, a 4G network, 5G network, or one of their successors, and one or more local area networks, for example, a Bluetooth™ network or Wi-Fi network, and combinations or derivatives thereof.

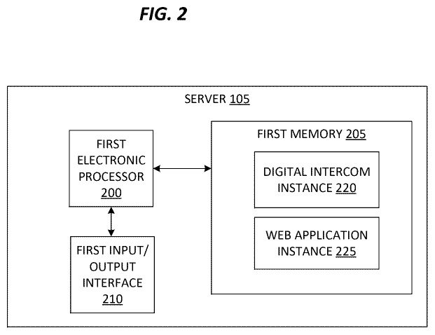

FIG. 2 illustrates an example of the components included in the server 105. In the example shown, the server 105 includes a first electronic processor 200 (for example, a microprocessor, application specific integrated circuit, etc.), a first memory 205, and a first input/output interface 210. The first memory 205 may be made up of one or more non-transitory computer-readable media. The first memory 205 can include combinations of different types of memory, such as read-only memory (“ROM”), random access memory (“RAM”), electrically erasable programmable read-only memory (“EEPROM”), flash memory, or other suitable memory devices. The first electronic processor 200 is coupled to the first memory 205 and the first input/output interface 210. The first electronic processor 200 sends and receives information (for example, from the first memory 205 and/or the first input/output interface 210) and processes the information by executing one or more software instructions or modules, capable of being stored in the first memory 205, or another non-transitory computer readable medium. The software can include firmware, one or more applications, program data, filters, rules, one or more program modules, and other executable instructions. In some examples, the first electronic processor 200 is configured to retrieve from the first memory 205 and execute, among other things, software for performing methods as described herein. In some implementations, the first memory 205 includes a digital intercom instance 220 and a web application instance 225.

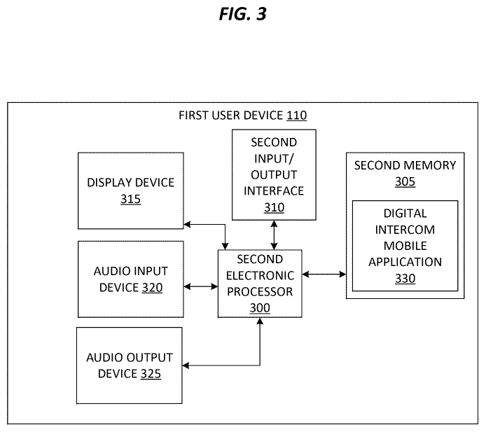

FIG. 3 illustrates an example of the components included in the first user device 110. In the example shown, the server 105 includes a second electronic processor, a second memory 305, a second communication interface 310, a display device 315, an audio input device 320 (for example, a microphone or microphone array), and an audio output device 325 (for example, a speaker, headphones, or earbuds). In some implementations, the second electronic processor 300, second memory 305, second communication interface 310 are configured and coupled in a manner similar to the first electronic processor 200, first memory 205, and first input/output interface 210. In some implementations, the display device 315, the audio input device 320, and the audio output device 325 may be coupled to the second electronic processor 300. In some implementations, the display device 315 may be, for example, a touchscreen, a liquid crystal display (“LCD”), a light-emitting diode (“LED”) display, an organic LED (“OLED”) display, an electroluminescent display (“ELD”), and the like. In some implementations, the first user device 110 may include more, fewer, or different components other than those illustrated herein. For example, the first user device 110 may include an input device such as a keypad, a mouse, a touchscreen (for example, as part of the display device 315), a camera, or the like.

In some implementations, the second memory 305 includes a digital intercom mobile application 330. When the second electronic processor 300 executes the digital intercom mobile application 330, the second electronic processor 300 may provide a virtual key panel and perform the functionality described below as being performed by the second electronic processor 300.

In some implementations, the second user device 115 and the third user device 120 include components and connections similar to those described above as being included in the first user device 110.

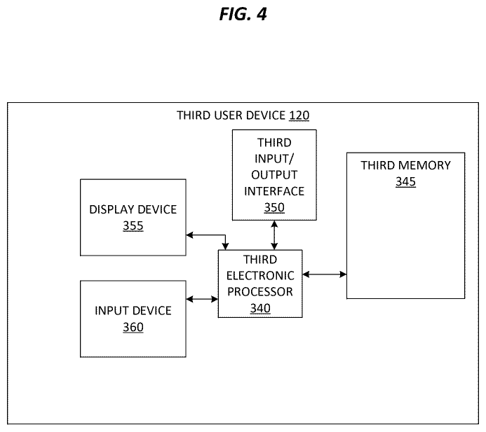

In other implementations, the third user device 120 includes the components and connections illustrated in FIG. 4. The third user device 120 may include a third electronic processor 340, a third memory 345, a third input/output interface 350, a display device 355, and an input device 360. The third electronic processor 340, third memory 345, and third input/output interface 350 may be configured and coupled in a manner similar to the first electronic processor 200, first memory 205, and first input/output interface 210 described above. In some implementations, the display device 355 and input device 360 are coupled to the third electronic processor 340. In some implementations, the display device 355 may be, for example, a touchscreen, a liquid crystal display (“LCD”), a light-emitting diode (“LED”) display, an organic LED (“OLED”) display, an electroluminescent display (“ELD”), and the like. The input device 360 may be, for example, a keypad, a mouse, a touchscreen (for example, as part of the display device 355), a camera, or the like.

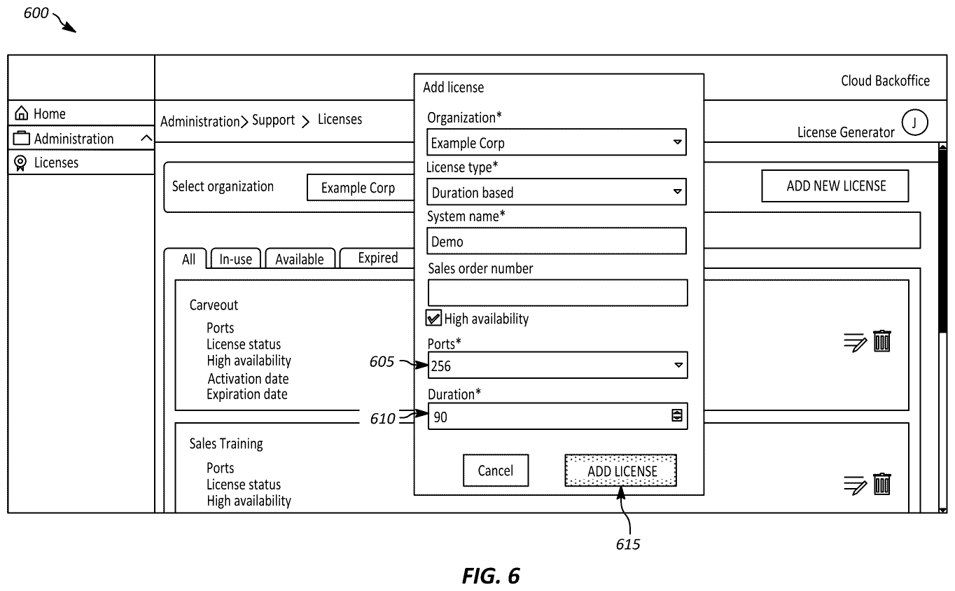

FIG. 5 provides an example method 400 for providing a digital intercom. In some implementations, the method 400 begins at block 405 when the first electronic processor 200 generates a digital intercom instance in a cloud environment. In some implementations, the digital intercom instance is generated in an Amazon Web Services (AWS) cloud environment. In some implementations, the electronic processor 200 creates a digital intercom instance when the first electronic processor 200 receives a JavaScript Object Notation (JSON) file from a user device (for example, the third user device 120). In some implementations, the JSON file includes instructions necessary to generate a CloudFormation stack for a digital intercom instance, more specifically, the JSON file includes computer executable instructions for implementing infrastructure as code (IaC). In some implementations, the first electronic processor 200, prior to receiving the JSON file, may receive instructions to create a virtual private cloud (VPC) associated with a user or a group of users in the AWS cloud environment and create an S3 bucket. An S3 bucket may be a storage location or container for storing programmatic objects in the AWS cloud environment. In some implementations, the third user device 120 may request and receive the JSON file from a server other than the server 105.

In some implementations, at block 410, the first electronic processor 200 generates an instance of a web application associated with the digital intercom instance. In some implementations, when the web application is generated, the first electronic processor 200 sends a uniform resource locator (URL) associated with the web instance to the third user device 120. Upon receiving a selection of the URL, the third electronic processor 340 may display the web application via the display device 355.

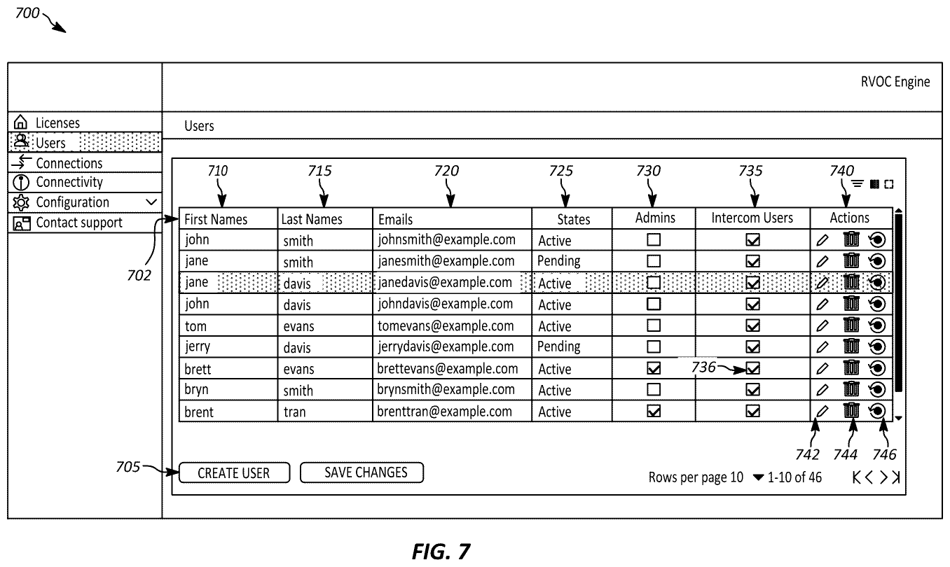

In some implementations, at block 415, the first electronic processor 200 receives, via the instance of the web application, a request to activate one or more communication channels. FIG. 6 is an example GUI 600 provided by the web application instance that allows a user to request to activate one or more communication channels or request a license. For example, the first electronic processor 200 receives a request to activate one or more communication channels when a number of ports is entered into the text field 605, an activation period is entered into the field 610, and the button 615 is selected. At block 420, the first electronic processor 200, in response to the request to activate the one or more communication channels, activates the one or more communication channels.

In some implementations, the first electronic processor 200 deactivates the one or more communication channels when the activation period has passed. Allowing users to select a number of communication channels and an activation period for communication channels ensures computer resources are preserved and operational and financial efficiency is provided. In some implementations, the first electronic processor 200 may, in response to receiving, from the third electronic processor 340, a request to edit the activation period, alter the activation period in accordance with the request. In some implementations, the first electronic processor 200 may in response to receiving, from the third electronic processor 340, a request to edit a number of active communication channels, increase or decrease a number of active communication channels in accordance with the request.

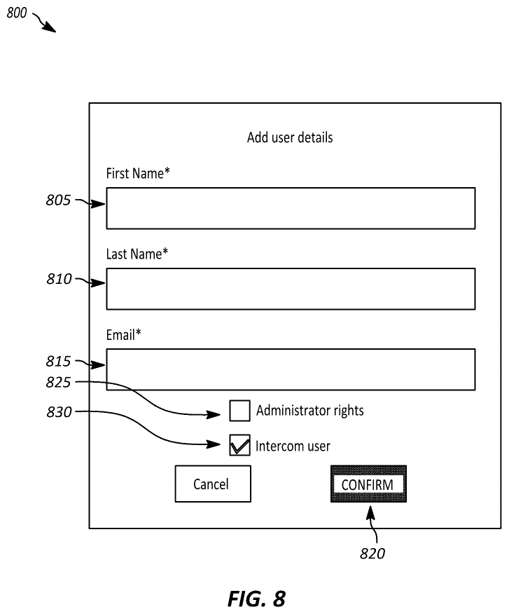

In some implementations, at block 425, the electronic processor 200 receives, via the instance of the web application, a request to allow one or more user devices access to the one or more communication channels. FIG. 7 is an example or a graphical user interface or GUI 700 of the web application with a table 702 including information and permissions associated with users who may connect user devices to the digital intercom instance 220 or the web application instance 225.

In one example, when the third electronic processor 340 receives a selection of a button 705, the third electronic processor 340 may display a pop-up, for example, the pop-up 800 illustrated in FIG. 8. In some implementations, the third electronic processor 340 receives information regarding a user device when text information is entered into the text fields 805, 810, and 815 and the button 820 is selected. In some implementations, the third electronic processor 340 receives a selection on the checkbox 825, the checkbox 830, or both. When the third electronic processor 340 receives a selection of the checkbox 825, the third electronic processor 340 sends and the first electronic processor 200 receives, via the instance of the web application 225, a request to allow a user device access to the instance of the web application 225. When a user device has access to the web application 225, the user device may request the generation of communication channels and that user devices be allowed to access to communication channels (the digital intercom instance 220) or the web application instance 225. When the third electronic processor 340 receives a selection of the checkbox 830, the third electronic processor 340 sends a request to allow a user device access to one or more communication channels included in the digital intercom instance 220.

Returning to FIG. 7, columns 710, 715, and 720 include information of users who are able to connect user devices to the digital intercom instance and/or the web application instance. Column 725 includes an indication of whether a user has connected a user device to the digital intercom instance 220. Column 730 provides an indication of whether a user has permission to access the instance of the web application 225. Column 735 provides an indication of whether a user has permission to access the instance of the digital intercom 220. In some implementations, when the third electronic processor 340 receives a selection of a check box included in the column 730 and column 735, the third electronic processor 340 sends, to the first electronic processor 200, a request to alter access permissions. For example, when user devices associated with a user have access to the digital intercom instance 220 (the checkbox 736 included in the column 735 is checked) and the third electronic processor 340 receives a selection to uncheck the checkbox 736, the third electronic processor 340 sends a request to revoke access to the digital intercom instance 220 for user devices associated with the user “brettevans@example.com.” Subsequently, when a user device that connected to the digital intercom instance using the email address “brettevans@example.com” requests access one or more communication channels, the first electronic processor 200 may deny the request for access. Column 740 includes one or more selectable icons. When the third electronic processor 340 receives a selection of the selectable icon 742, the third electronic processor 340 may generate a GUI via which information may be received and used to update the table 702. When the third electronic processor 340 receives a selection of the selectable icon 744, the third electronic processor 340 may send, to the first electronic processor 200, a request to remove access permissions of one or more user devices (for example, user devices connected to the digital intercom instance 220 and associated with the user “brent tran”) to the digital intercom instance 220. In response to receiving the request, the first electronic processor 200 may remove access permissions to the digital intercom instance 220 of the one or more user devices included in the request. When the third electronic processor 340 receives a selection of the selectable icon 746, the third electronic processor 340 may generate a GUI via which a new password for one or more user devices (for example, user devices associated with the user “brent tran”) may be received.

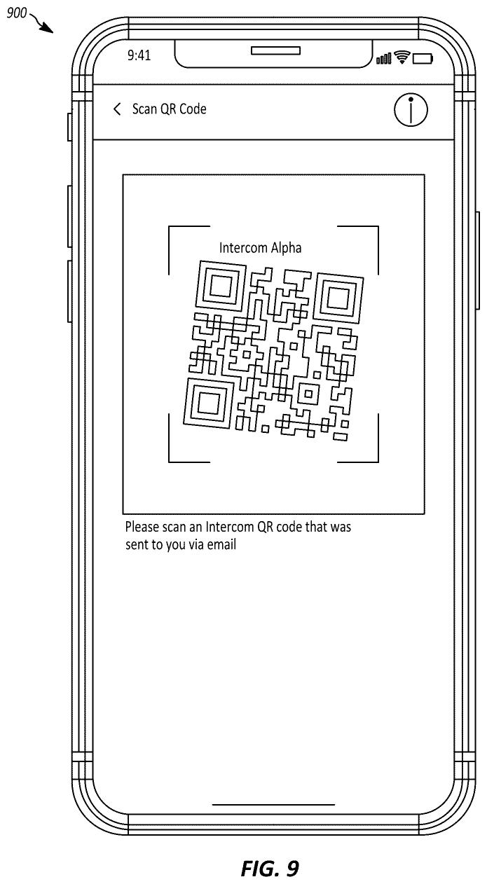

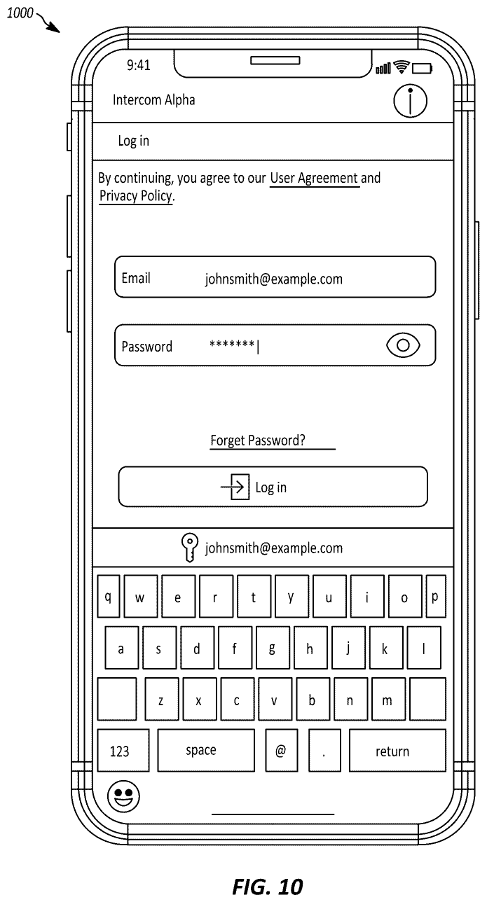

In some implementations, when the first electronic processor 200 receives a request to allow one or more user devices access to one or more communication channels included in the digital intercom, the first electronic processor 200 sends a quick response (QR) code to one or more email addresses included in the request. When, for example, the first user device 110 scans the QR code using, for example, a camera, the second electronic processor 300 may generate a GUI. FIG. 9 includes an example of a GUI 900 generated to prompt a user to scan a QR code. FIG. 10 is an example of a GUI 1000 generated when the first user device 110 scans the QR code. When the second electronic processor 300 receives, via the GUI 1000, requested information (for example, a username, an email address, a password, a combination of the foregoing, or the like), the second electronic processor 300 may send to the first electronic processor 200, the requested information. Upon receiving the requested information, the first electronic processor 200 may, at block 430, permit the one or more user devices access to the one or more communication channels via a mobile application. In some implementations, the one or more user devices with access to the one or more communication channels communicate with the first electronic processor 200 via an application programming interface (API)

In some implementations, the first electronic processor 200 receives, from a user device (for example, the first user device 110), a request to utilize a communication channel of the one or more communication channels of the digital intercom instance 220. In some implementations, in response to receiving the request to utilize a communication channel of the one or more communication channels, the first electronic processor 200, determines whether a communication channel of the one or more communication channels is active and available. For example, a communication channel in the digital intercom instance 220 is available when the communication channel is not being used by a user device (other than the requesting user device) to send and receive audio data.

In some implementations, in response to receiving the request to utilize a communication channel of the one or more communication channels, the first electronic processor 200, determines whether the user device is allowed to access the one or more communication channels. For example, a user device may be allowed to access a communication channel included in the digital intercom instance 220, when a the first electronic processor 200 has received, via the instance of the web application 225, a request to allow the user device access to the one or more communication channels and has not received, via the instance of the web application 225, a request to revoke the user device's access to the one or more communication channels.

In some implementations, in response to determining a communication channel of the one or more communication channels is active and available and the user device is allowed to access the one or more communication channels, the first electronic processor 200 allows utilization of the communication channel. When the first electronic processor 200 allows utilization of the communication channel, the first user device 110 may send and receive audio data from another user device (for example, the second user device 115) connected to (or allowed to access) the one or more communication channels included in the digital intercom instance 220.

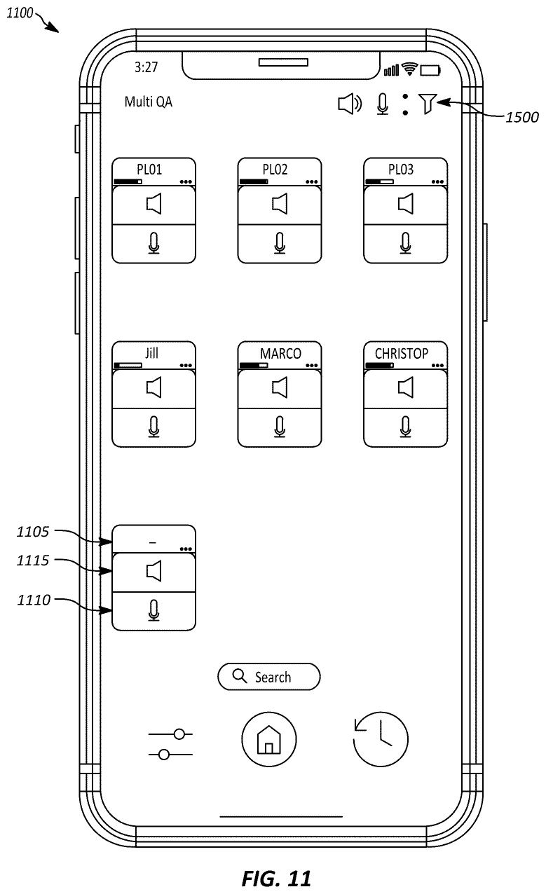

In some implementations, when a user device (for example, the user device 110) is allowed access to one or more communication channels included in the digital intercom instance 220, the second electronic processor 300, executing the digital intercom mobile application 330, generates, for display via a GUI, one or more tiles. FIG. 11 is a GUI 1100 including a plurality of tiles. Each tile may be assigned to a user device. In some implementations a tile can be assigned to multiple user devices or a group of user devices. A tile (for example, the tile 1105) may be displayed that is not yet assigned to a user device. In some implementations, each tile is associated with a microphone button 1110 that, when selected, causes the second electronic processor 300 to transmit audio received via the audio input device 320 of the first user device 110 to another user device connected to the digital intercom instance. Specifically, the second electronic processor 300 transmits audio data received via the audio input device 320 of the first user device 110 to the first electronic processor 200 of the server 105 along with an indication of one or more user devices (for example, the second user device 115) to send the audio data to. The first electronic processor 200 may send the audio data to the one or more user devices (for example, the second user device 115) in response to receiving the audio data from the first user device 110.

In some implementations, each tile is associated with a listen button 1115 that, when selected, causes the second electronic processor 300 to output, via the audio output device 325, audio data received by the first user device 110 from another user device connected to the digital intercom instance 220. In some implementations, when a selection or deselection of a listen button is received, the second electronic processor 300 sends, to the first electronic processor 200, a indication of the selection or deselection of a listen button and an indication of the user device or devices associated with the selection or deselection. The first electronic processor 200 may utilize this information to mix audio data to transmit to the first user device 110.

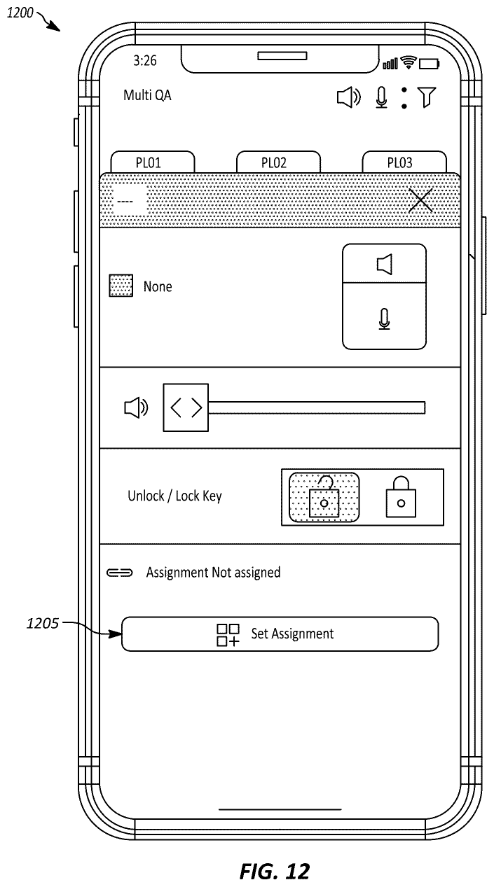

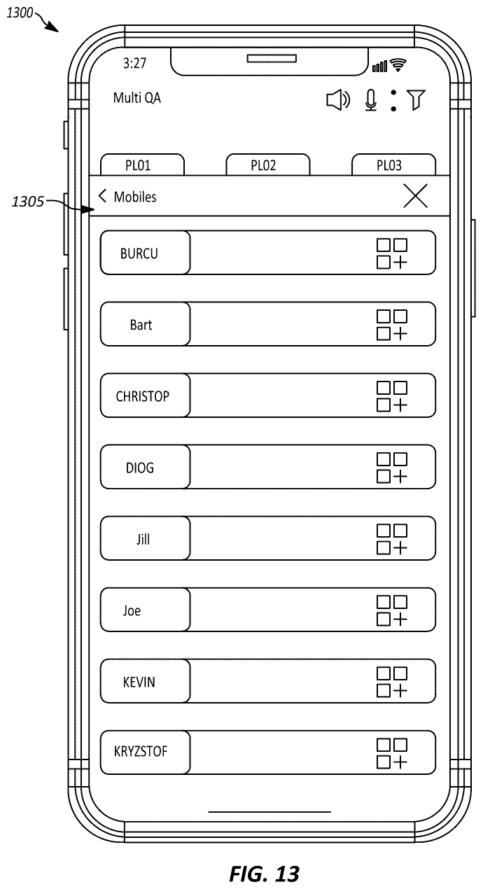

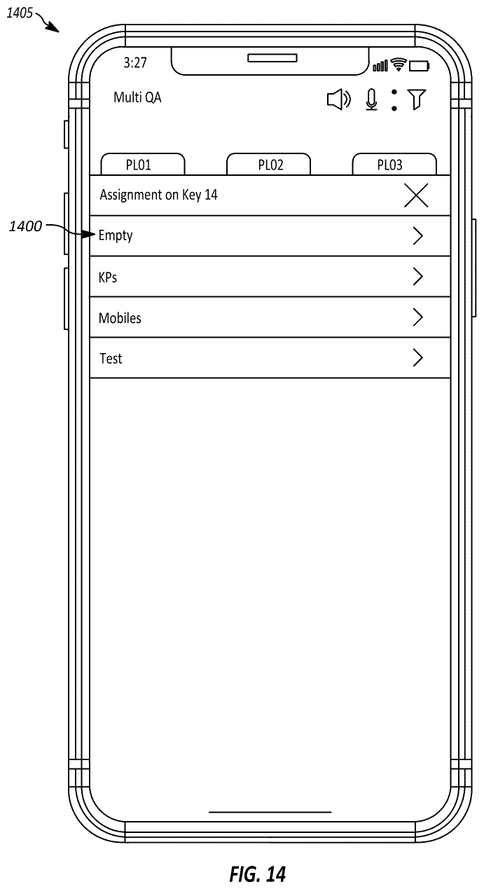

In some implementations, a tile may be assigned to a communication channel or user device (or group of communication channels or user devices) or reassigned to a different communication channel or user device (or group of communication channels or user devices). For example, in response to receiving a selection of a tile, the second electronic processor 300 generates, for display via the GUI, a button. For example, when the second electronic processor 300 receives a selection of the tile 1105, the second electronic processor 300 may generate, for display, a GUI 1200 including the button 1205, as illustrated in FIG. 12. In some implementations, in response to receiving a selection of the button 1205, the second electronic processor 300 generates, for display, a menu including user devices utilizing a communication channel of the one or more communication channels. In some implementations, in response to receiving a selection of a user device from the menu, the second electronic processor 300 associates the tile 1105 with the selected user device. FIG. 13 is an example GUI 1300 including a menu 1305 of user devices utilizing a communication channel of the one or more communication channels. In some implementations, the second electronic processor 300 may generate, for display via a GUI, a menu of categories such as the menu of categories 1400 included in the GUI 1405 and receive a selection of a category prior to generating, for display, a menu including user devices utilizing a communication channel of the one or more communication channels.

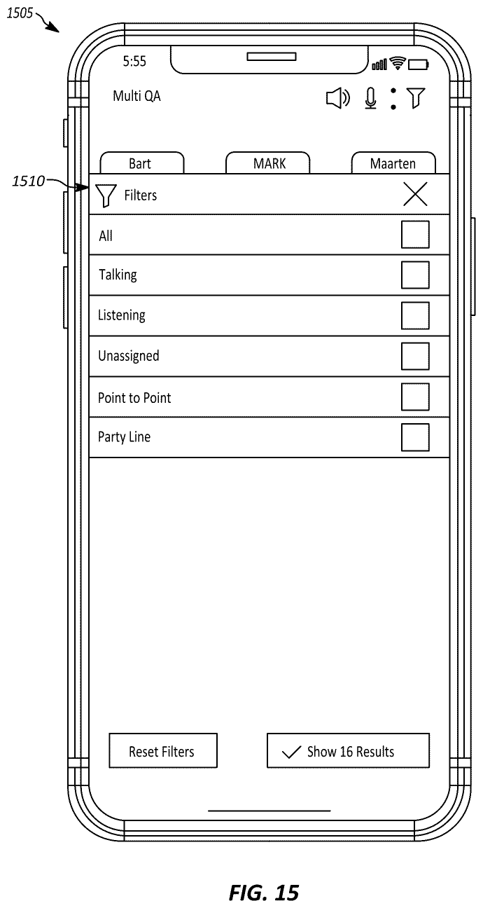

Returning to FIG. 11, when the second electronic processor 300 receives a selection of the icon 1500, the second electronic processor 300 may generate, for display, a menu including one or more criteria for filtering tiles. FIG. 15 is an example GUI 1505 including a menu 1510 of filter criteria. In some implementations, the second electronic processor 300 receives from, for example the menu 1510, a selection of one or more criteria to filter tiles. In some implementations, the one or more criteria include talking, listening, unassigned, point to point, party line, and favorites (not illustrated in FIG. 15). In some implementations, in response to receiving the selection of the one or more criteria, the second electronic processor 300 generates, for display via a GUI, one or more tiles that meet the one or more criteria. In some implementations, tiles that do not meet the one or more criteria are not be displayed via the GUI.

For example, when a selection of “talking” is received from the menu 1510, the second electronic processor 300 displays tiles with the associated talk button (for example, the button 1110) selected. In another example, when a selection of “listening” is received from the menu 1510, the second electronic processor 300 displays tiles with the associated listen button (for example, the button 1115) selected. In another example, when a selection of “point to point” is received from the menu 1510, the second electronic processor 300 displays tiles associated with a single user device. In another example, when a selection of “party line” is received from the menu 1510, the second electronic processor 300 displays tiles associated with a group of user devices.

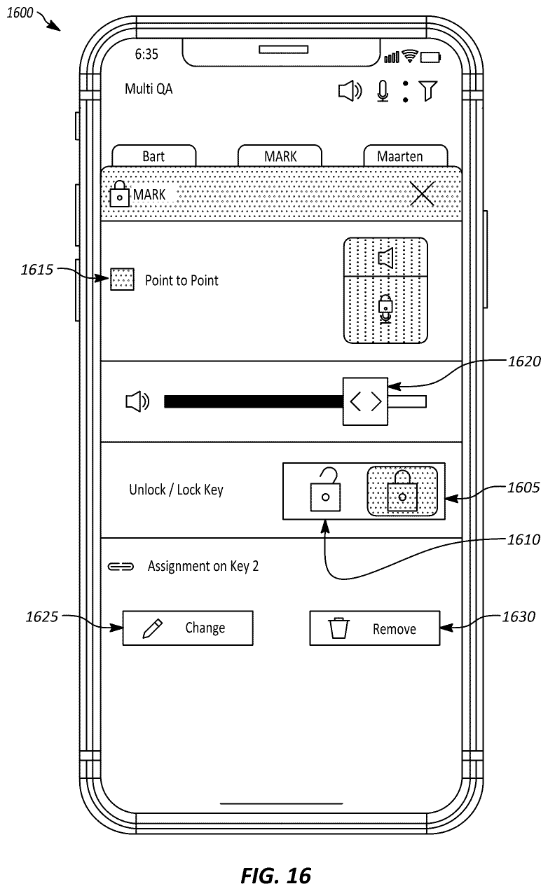

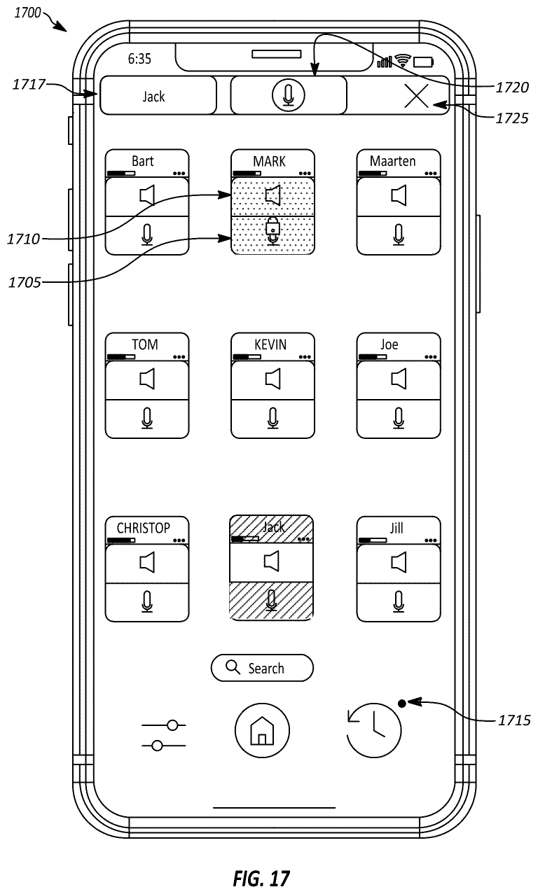

In some implementations, in response to receiving a selection of a tile associated with a user device utilizing a communication channel, the second electronic processor 300 displays an option to lock or unlock the tile. FIG. 16 is an example GUI 1600 including a button 1605 to lock a tile and a button 1610 to unlock a tile. In some implementations, in response to receiving a selection to lock the tile (for example, the lock button 1605), the second electronic processor 300 disables a talk button and a listen button associated with the tile. For example, FIG. 17 includes an example GUI 1700 in which a talk button 1705 and a listen button 1710 are locked or disabled. In some implementations, when the talk button and/or listen button are disabled and a selection of the talk button and/or listen button is received, the second electronic processor 300 takes no action. In some implementations, in response to receiving a selection to unlock the tile (for example, the unlock button 1610), the second electronic processor 300 enables the talk button and the listen button (for example, the talk button 1705 and the listen button 1710) associated with the tile.

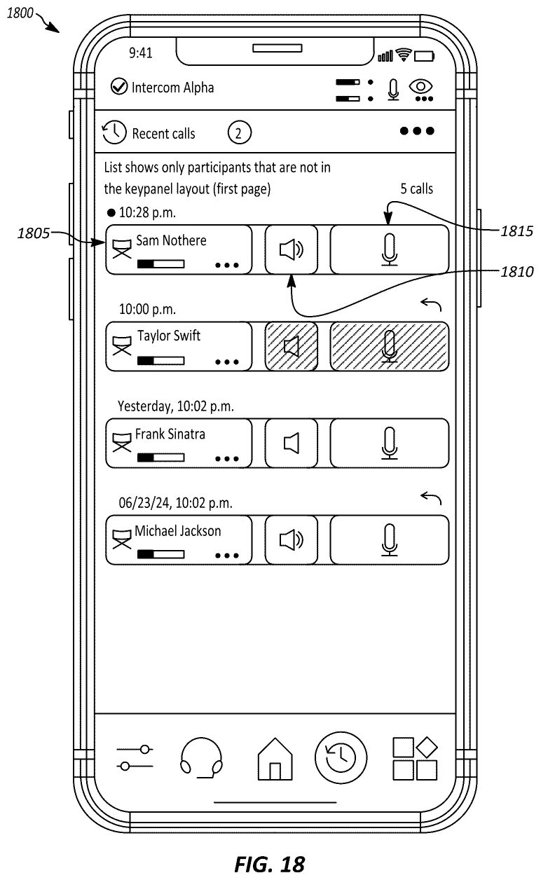

In some implementations, when the second electronic processor 300 receives a selection of a recent calls icon 1715, the second electronic processor 300 generates a GUI including a list of recent calls received via the digital intercom instance 220. In some implementations, a notification is displayed near or overlaid on the recent calls icon 1715 when a call was received via the digital intercom instance but was unanswered. FIG. 18 is an example GUI 1800 including a list of recent calls. Each recent call included in the list of recent calls may be associated with one or more buttons. For example, the recent call 1805 is associated with a listen button 1810 and a talk button 1815. In some implementations, a button to assign a recent caller to a tile and a button to delete the recent call from the recent call list are displayed.

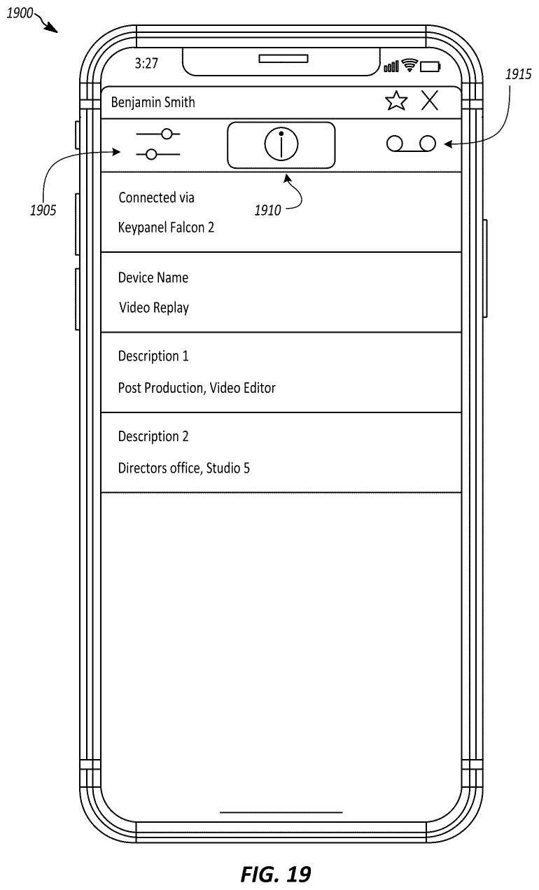

In some implementations, when a tile is selected the second electronic processor 300 may generate a GUI with a ribbon including multiple icons. FIG. 19 is an example GUI including a ribbon 1900 including a settings icon 1905, an information icon 1910, and a voicemail icon 1915. When the second electronic processor 300 receives a selection of the information icon 1910, the second electronic processor 300 generates, for display, metadata associated with the tile. When the second electronic processor 300 receives a selection of the voicemail icon 1915, the second electronic processor 300 may play one or more voicemails left by user devices calling the first user device 110 via the digital intercom instance 220. When the second electronic processor 300 receives a selection of the voicemail icon 1915, the second electronic processor 300 may generate a GUI allowing voice mails to be left for other user devices connected via the digital intercom instance 220.

Returning to FIG. 16, in some implementations, when a selection of the settings icon 1905 is received by the second electronic processor 300, the second electronic processor 300 may display the GUI 1600. The GUI 1600 may include an indication 1615 of the type of connection associated with a tile (for example, “point to point” in FIG. 16). The GUI 1600 may also include a slider 1620. When a movement of the slider 1620 is received, the second electronic processor 300 may send the selected position of the slider 1620 to the first electronic processor 200 and the first electronic processor 200 may adjust a volume associated with audio received from the user device or communication channel associated with the tile in accordance with the selected position of the slider 1620. In some implementations, when a selection of a button 1625 is received, the second electronic processor 300 may generate a GUI for selecting a different user device or user devices to be associated with the tile. In some implementations, when a selection of a button 1630 is received, the second electronic processor 300 removes the user device or user devices associated with the tile. In other words, when a selection of the button 1630 is received the tile may not be associated a user device or user devices.

Returning to FIG. 17, when the second electronic processor 300 receives a call from another user device (for example, the second user device 115) via a communication channel of the digital intercom instance 220, the second electronic processor 300 may display a notification banner such as the notification banner 1717. The notification banner 1717 may include a button to answer the call (for example, the button 1720) and a button to dismiss the notification (for example, the button 1725).

In some implementations, when the second electronic processor 300 receives a press and hold selection of a tile, the second electronic processor 300 generates a GUI in which the selected tile moves on the GUI until the tile is deselected. In other words, tiles may be dragged and dropped and, thus, repositioned in a GUI.

In some implementations, the second electronic processor 300 provides a notification or icon indicating whether or not a user device associated with a tile is currently connected to the digital intercom instance.

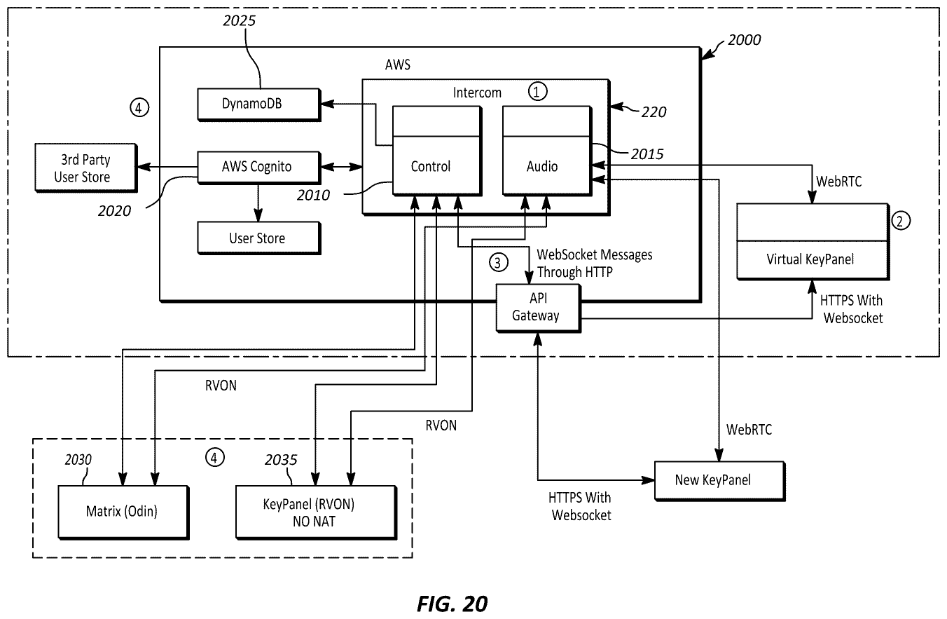

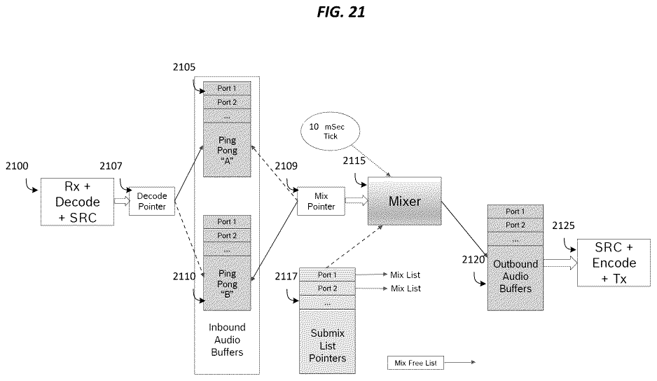

FIG. 20 is an example block diagram of software components included in a system for implementing a digital intercom. As described above a digital intercom instance may be implemented in the AWS cloud 2000. The digital intercom instance 220 included in the AWS cloud 2000 may include a control plane 2010 and an audio plane 2015. The audio plane 2015, when executed by an electronic processor (for example, the first electronic processor 200), performs audio encoding, audio decoding, and audio mixing.

FIG. 21 is an example block diagram of functionality performed when the audio plane 2015 is executed by the first electronic processor 200. Specifically, the audio plane 2015 may include a virtual audio mixer and FIG. 21 provides an example of audio mixing functionality that may be performed when the audio plane 2015 is executed by the first electronic processor 200. Hardware based intercoms may include a backplane and a hardware-based audio mixer may mix each sample of audio data received for each communication channel every 22 microseconds. At least because a backplane is unavailable in the software based digital intercom, audio mixing in the cloud based digital intercom is performed differently from audio mixing in hardware-based solutions.

In some implementations, the first electronic processor 200 receives, from one or more user devices via one or more communication channels, one or more packets of audio data. In some implementations, the first electronic processor 200, at block 2100, decodes the audio data included in the packets. In some implementations, audio data may need to be associated with a predetermined sample rate to be mixed by the first electronic processor 200. In some implementations, the sample rate of the received audio data varies depending on the user device the audio data is received from. Therefore, in some implementations, at block 2100, when received audio data is not associated with the predetermined sample rate, the first electronic processor 200 performs sample rate conversion (SRC) on the received audio data to convert the received audio data to the predetermined sample rate.

In some implementations, decoded audio data is stored in an inbound audio buffer by the first electronic processor 200. In some implementations, the inbound audio buffer is a ping-pong buffer (for example, a first ping pong buffer 2105). In the example illustrated in FIG. 21, pointers associated with the decoder functionality and the mixer functionality are swapped once a period or once a clock cycle. Pointers may be swapped once every 10 milliseconds, 20 milliseconds, or the like. For example, in the example illustrated in FIG. 21, during a first period, a decoder pointer 2107 may point to the first ping pong buffer 2105. Therefore, during the first period, the first electronic processor 200 may write decoded (and, in some instances, sample converted audio data) to the first ping pong buffer 2105. Continuing with this example, during the first period, a mixer pointer 2109 may point to a second ping pong buffer 2110. Therefore, during the first period, the first electronic processor 200 may read decoded audio data for mixing from the second ping pong buffer 2110. During a second period, the first electronic processor 200 may read decoded audio data for mixing from the first ping pong buffer 2105 and write decoded (and, in some instances, sample converted audio data) to the second ping pong buffer 2110.

At block 2115, the first electronic processor 200 may mix decoded audio data read from the first ping pong buffer 2105 or the second ping pong buffer 2110. In some implementations, the first electronic processor 200 utilizes a plurality of pointers 2117 to mix decoded audio data. Each pointer of the plurality of pointers 2117 may be associated with a user device connected to the digital intercom instance 220 and point to a linked list including instructions for mixing audio data to transmit to a connected user device. For example, the linked list may include which communication channels or user devices a user has selected (for example, which communication channels or user devices a selection of a listen button (for example, the listen button 1115) is received by the first electronic processor 200 from the first user device 110) and a selected volume for one or more user devices or communication channels (for example, a selected volume based on a received position of a slider such as the slider 1620).

In some implementations, when a selection to unmute a communication channel or user device is received, audio data associated with the newly unmuted communication channel may be ramped up during mixing for one period (for example, for 10 milliseconds) to prevent audio artifacts (for example, clicking and popping noises) from being output. Because ramping is a computationally demanding process, ramping may be performed for a single period in order to conserve computer resources.

In some implementations, the first electronic processor 200 writes mixed audio data into an outbound audio buffer 2120. In some implementations, the outbound audio buffer 2120 is a pair of ping pong buffers. In some implementations, the first electronic processor 200 reads mixed audio data from the outbound audio buffer and, at block 2125 encodes the mixed audio data prior to transmitting the mixed audio data to a user device. In some implementations, the first electronic processor 200 performs sample rate conversion on the mixed audio data based on the sample rate associated with the user device receiving the mixed audio data (the user device the mixed audio data is transmitted to).

In some implementations, the functionality described in relation to FIG. 21 as being performed by the first electronic processor 200 may be performed by multiple electronic processors. For example, one electronic processor may perform audio data decoding while another electronic processor performs audio data mixing, and yet another electronic processor performs audio data encoding. Utilizing multiple electronic processors may allow audio data decoding, mixing, and encoding to occur in parallel. In some implementations, audio mixing may be performed by multiple electronic processors. For example, each electronic processor may perform audio mixing in accordance with the data included in a single linked list pointed to by a pointer in the plurality of pointers 2117. In some implementations, the plurality of pointers 2117 and the linked lists that they point to are utilized by multiple electronic processors and, to ensure that the electronic processors are accessing up to date data in the linked lists, semaphore programming techniques may be utilized.

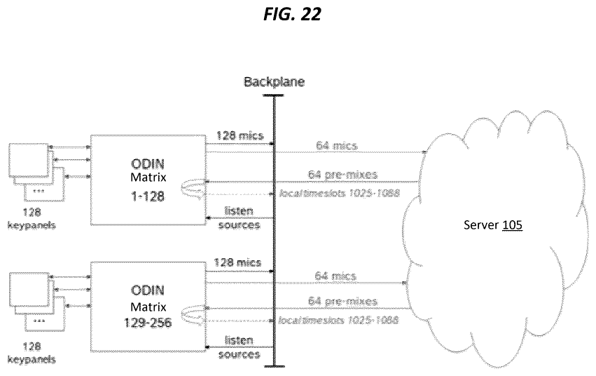

Returning to FIG. 20, in some implementations, AWS Cognito may be utilized to integrate 3rd party user application stores to enable user devices to download the digital intercom mobile application from user application stores. In some implementations, a database (for example, a Dynamo database 2025) may be utilized to store access permissions to the digital intercom 220 associated with user devices and licenses associated with the digital intercom 220. In some implementations, the digital intercom instance 220 may be configured to connect to existing hardware based intercom components such as hardware based matrixes (for example, the matrix 2030) and legacy key panels (for example, the key panel 2035) via RVON (voice over network software provided by RTS) technology and trunk master software provided by RTS. In these implementations, the first electronic processor 200 receives audio data from and transmits audio data to hardware based matrixes. The hardware-based matrixes may transmit the audio data to and receive audio data from one or more user devices or legacy key panels without performing audio mixing. FIG. 22 is an example diagram depicting communications between hardware matrixes and the server 105. In some implementations, an electronic processor included in a hardware based matrix may encode audio data and transmit the encoded audio data to the server 105 and decode audio data received from the server 105.

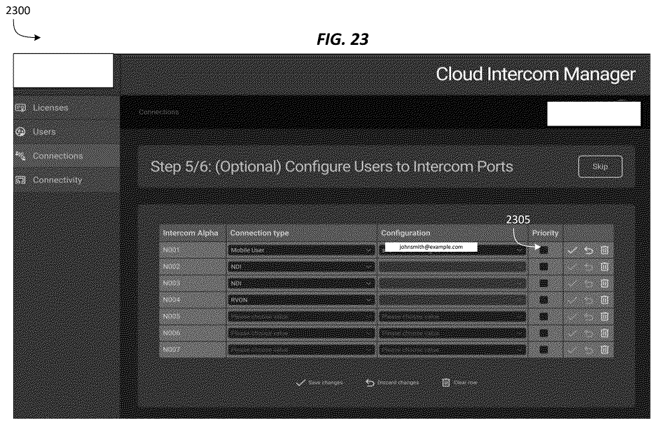

In some implementations, the first electronic processor 200 receives via the web application instance 225 a request to assign a user device to a specific communication channel of the digital intercom instance 220. In some implementations, the request may specify the type of user device assigned to the communication channel (for example, whether the user device is a mobile device connecting to the digital intercom via the mobile application, a legacy key panel connecting to the digital intercom instance 220 via RVON, or a mixing console connecting to the digital intercom instance 220 via Network Device Interface (NDI)). FIG. 23 is an example GUI 2300 via which selections of communication channel assignments may be received. In some implementations, the first electronic processor 200 receives a selection of one or more communication channels to prioritize. For example, the first electronic processor 200 receives a selection to prioritize communications from a user device associated with “johnsmith@example.com,” when the check box 2305 is selected. When resources are limited, the first electronic processor 200 may prioritize sending communications to and receiving communications from the user device associated with “johnsmith@example.com.”

Thus, examples, aspects, and features herein provide, among other things, systems and methods for providing a digital intercom.

What is claimed is:

1. A system for providing a digital intercom, the system comprising:
an electronic processor, the electronic processor configured to
generate a digital intercom instance in a cloud environment;
generate an instance of a web application associated with the digital intercom instance;
receive, via the instance of the web application, a request to activate one or more communication channels;
in response to the request to activate the one or more communication channels, activate the one or more communication channels;
receive, via the instance of the web application, a request to allow one or more user devices access to the one or more communication channels; and
permit the one or more user devices access to the one or more communication channels via a mobile application.

2. The system according to claim 1, wherein the electronic processor is further configured to
receive, via the instance of the web application, a request to allow one or more user devices access to the instance of the web application, wherein the web application generates communication channels and allows user devices access to communication channels or a web application in response to receiving requests from user devices with access to the instance of the web application.

3. The system according to claim 1, wherein the request to activate one or more communication channels includes an activation period and the electronic processor is further configured to
deactivate the one or more communication channels when the activation period has passed.

4. The system according to claim 1, the electronic processor configured to:
receive, from a user device, a request to utilize a communication channel of the one or more communication channels; and
in response to receiving the request to utilize a communication channel of the one or more communication channels,
determine whether a communication channel of the one or more communication channels is active and available, wherein a communication channel is available when the communication channel is not being used;
determine whether the user device is allowed to access the one or more communication channels; and
in response to determining a communication channel of the one or more communication channels is active and available and the user device is allowed to access the one or more communication channels, allow utilization of the communication channel.

5. The system according to claim 1, the electronic processor configured to:
receive, from the one or more user devices via the one or more communication channels, one or more packets of audio data;
decode the received audio data;
write the decoded audio data to a first buffer for a predetermined period;
read the decoded audio data from the first buffer for the predetermined period;
mix the decoded audio data based on instructions included in one or more linked lists;
encode the mixed audio data; and
transmit the encoded audio data to the one or more user devices.

6. The system according to claim 5, wherein the predetermined period is 10 milliseconds and the buffer is a ping pong buffer.

7. The system according to claim 5, the electronic processor configured to:
when the received audio data is not associated with a predetermined sample rate, perform a sample rate conversion on the received audio data; and
perform a sample rate conversion on the mixed audio data based on a user device the mixed audio data is transmitted to.

8. The system according to claim 1, the system further comprising:
a user device including an electronic processor, wherein the electronic processor of the user device is further configured to:
generate, for display via a graphical user interface (GUI), one or more tiles;
in response to receiving a selection of a tile, generate, for display via the GUI, a button;
in response to receiving a selection of the button, generate, for display via the GUI, a menu including user devices utilizing a communication channel of the one or more communication channels; and
in response to receiving a selection of a user device from the menu, associate the tile with the selected user device.

9. The system according to claim 1, the system further comprising:
a user device including an electronic processor, wherein the electronic processor of the user device is further configured to:
receive a selection of a tile associated with a user device utilizing a communication channel; and
in response to receiving a selection of the tile,
display an option to lock or unlock the tile;
in response to receiving a selection to lock the tile, disable a talk button and a listen button associated with the tile; and
in response to receiving a selection to unlock the tile, enable the talk button and the listen button associated with the tile.

10. The system according to claim 1, the system further comprising:
a user device including an electronic processor, wherein the electronic processor of the user device is further configured to:
receive a selection of one or more criteria to filter tiles, wherein the one or more criteria include at least one selected from the group consisting of talking, listening, unassigned, point to point, party line, and favorites; and
in response to receiving the selection of the one or more criteria, generate, for display via a graphical user interface (GUI), one or more tiles that meet the one or more criteria.

11. A method for providing a digital intercom, the method comprising:
generating a digital intercom instance in a cloud environment;
generating an instance of a web application associated with the digital intercom instance;
receiving, via the instance of the web application, a request to activate one or more communication channels;
in response to the request to activate the one or more communication channels, activating the one or more communication channels;
receiving, via the instance of the web application, a request to allow one or more user devices access to the one or more communication channels; and
permitting the one or more user devices access to the one or more communication channels via a mobile application.

12. The method according to claim 11, the method further comprising:
receiving, via the instance of the web application, a request to allow one or more user devices access to the instance of the web application, wherein the web application generates communication channels and allows user devices access to communication channels or a web application in response to receiving requests from user devices with access to the instance of the web application.

13. The method according to claim 11, wherein the request to activate one or more communication channels includes an activation period and the method further includes:
deactivating the one or more communication channels when the activation period has passed.

14. The method according to claim 11, the method further comprising:
receiving, from a user device, a request to utilize a communication channel of the one or more communication channels; and
in response to receiving the request to utilize a communication channel of the one or more communication channels,
determining whether a communication channel of the one or more communication channels is active and available, wherein a communication channel is available when the communication channel is not being used;
determining whether the user device is allowed to access the one or more communication channels; and
in response to determining a communication channel of the one or more communication channels is active and available and the user device is allowed to access the one or more communication channels, allowing utilization of the communication channel.

15. The method according to claim 11, the method further comprising:
receiving, from the one or more user devices via the one or more communication channels, one or more packets of audio data;
decoding the received audio data;
writing the decoded audio data to a first buffer for a predetermined period;
reading the decoded audio data from the first buffer for the predetermined period;
mixing the decoded audio data based on instructions included in one or more linked lists;
encoding the mixed audio data; and
transmitting the encoded audio data to the one or more user devices.

16. The method according to claim 15, wherein the predetermined period is 10 milliseconds and the buffer is a ping pong buffer.

17. The method according to claim 15, the method further comprising:
when the received audio data is not associated with a predetermined sample rate, performing a sample rate conversion on the received audio data; and
performing a sample rate conversion on the mixed audio data based on a user device the mixed audio data is transmitted to.

18. The method according to claim 11, the method further comprising:
generating, for display via a graphical user interface (GUI), one or more tiles;
in response to receiving a selection of a tile, generating, for display via the GUI, a button;
in response to receiving a selection of the button, generating, for display via the GUI, a menu including user devices utilizing a communication channel of the one or more communication channels; and
in response to receiving a selection of a user device from the menu, associating the tile with the selected user device.

19. The method according to claim 11, the method further comprising:
receiving a selection of a tile associated with a user device utilizing a communication channel; and
in response to receiving a selection of the tile,
displaying an option to lock or unlock the tile;
in response to receiving a selection to lock the tile, disabling a talk button and a listen button associated with the tile; and
in response to receiving a selection to unlock the tile, enabling the talk button and the listen button associated with the tile.

20. The method according to claim 11, the method further comprising:
receiving a selection of one or more criteria to filter tiles, wherein the one or more criteria include at least one selected from the group consisting of talking, listening, unassigned, point to point, party line, and favorites; and
in response to receiving the selection of the one or more criteria, generating, for display via a graphical user interface (GUI), one or more tiles that meet the one or more criteria.
